(19) United States
(12) Patent Application Publication
(10) Pub. No.: US 2010/0264868 A1
(43) Pub. Date: Oct. 21, 2010

(54) METHODS AND APPARATUS TO COUPLE AN ELECTRO-PNEUMATIC CONTROLLER TO A POSITION TRANSMITTER IN A PROCESS CONTROL SYSTEM

(76) Inventors: Stephen George Seberger, Marshalltown, IA (US); Steven William Hagen, Marshalltown, IA (US); Lorin Dion Miller, Colo, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/424,347

(22) Filed: Apr. 15, 2009

(51) Int. Cl. G05B 11/10

(52) U.S. Cl. 318/671

(57) ABSTRACT

Example methods and apparatus to couple an electro-pneumatic controller to a position transmitter in a process control system are disclosed. A disclosed example apparatus includes a position transmitter having a first connection and having a second connection coupled to a power source, an electro-pneumatic controller including at least a first connection coupled to the first connection of the position transmitter, and a resistor coupled between the first connection and a second connection of the electro-pneumatic controller.

### FIELD OF DISCLOSURE

The present disclosure relates generally to controllers and, more particularly, to methods and apparatus to couple an electro-pneumatic controller to a position transmitter in a process control system.

### BACKGROUND

Electronic control devices (e.g., an electro-pneumatic controller, programmable controllers, analog control circuits, etc.) are typically used to control process control devices (e.g., control valves, pumps, dampers, etc.). These electronic control devices cause a specified operation of the process control devices. For purposes of safety, cost efficiency, and reliability, many well-known diaphragm-type or piston-type pneumatic actuators are used to actuate process control devices and are typically coupled to the overall process control system via an electro-pneumatic controller. Electro-pneumatic controllers are usually configured to receive one or more control signals and convert those control signals into a pressure provided to a pneumatic actuator to cause a desired operation of the process control device coupled to the pneumatic actuator. For example, if a process control routine requires a pneumatically-actuated valve to pass a greater volume of a process fluid, the magnitude of the control signal applied to an electro-pneumatic controller associated with the valve may be increased (e.g., from 10 milliamps (mA) to 15 mA in a case where the electro-pneumatic controller is configured to receive a 4-20 mA control signal).

Electro-pneumatic controllers typically use a feedback signal generated by a feedback sensing system or element (e.g., a position sensor) that senses or detects an operational response of a pneumatically-actuated control device. For example, in the case of a pneumatically-actuated valve, the feedback signal may correspond to the position of the valve as measured or determined by a position sensor. The electro-pneumatic controller compares the feedback signal to a desired set-point or control signal and utilizes a position control process to generate a drive value based on (e.g., a difference between) the feedback signal and the control signal. This drive value corresponds to a pressure to be provided to the pneumatic actuator to achieve a desired operation of the control device (e.g., a desired position of a valve) coupled to the pneumatic actuator.

### SUMMARY

Example methods and apparatus to couple an electro-pneumatic controller to a position control transmitter in a process control system are described. An example apparatus includes a position transmitter having a first connection and having a second connection coupled to a power source, an electro-pneumatic controller including at least a first connection coupled to the first connection of the position transmitter, and a resistor coupled between the first connection and a second connection of the electro-pneumatic controller.

Another disclosed example apparatus includes a position transmitter having first and second connections and an electrical isolator having first, second, and third connections, wherein the third connection of the electrical isolator is coupled to the second connection of the position transmitter. The example apparatus further includes an electro-pneumatic controller including at least a first connection coupled to the first connection of the position transmitter and the first connection of the electrical isolator, wherein the electro-pneumatic controller includes a second connection coupled to the second connection of the electrical isolator.

A disclosed example method includes coupling a first connection of an electro-pneumatic controller to a first connection of a position transmitter and coupling the electro-pneumatic controller to a resistor by coupling the resistor between the first connection and a second connection of the electro-pneumatic controller. The example method further includes coupling a second connection of the position transmitter to a power source.

### BRIEF DESCRIPTION OF THE DRAWINGS

FIG. 1 is a diagram of an example process control system including an example configuration for an electro-pneumatic controller, a position transmitter, coupled to an electrical isolator.

FIG. 2 is a diagram of an example process control system including the example electro-pneumatic controller and position transmitter of FIG. 1 coupled to a DC power supply.

FIGS. 3 and 4 are flowcharts of example methods that may be used to couple the example electro-pneumatic controller, the example position transmitter, and/or the example electrical isolator in the configurations shown in FIGS. 1 and 2.

### DETAILED DESCRIPTION

Although the following describes example methods and apparatus including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the following describes example methods and apparatus, the examples provided are not the only way to implement such methods and apparatus.

Typically, in a process control system, an electro-pneumatic controller is directly coupled to a control device, (e.g., a control valve, a pump, a damper, etc.). A position sensor coupled to the control device measures the movement of an actuator coupled to the control device. The position sensor may transmit a feedback signal including a current with a magnitude that corresponds to the travel or position of the actuator. The electro-pneumatic controller determines a position of the actuator based on a voltage differential that is generated across a resistor as a result of the feedback current signal originating from the position sensor. However, in some applications, the electro-pneumatic controller may not be directly coupled to the control device due to adverse environmental conditions at the location of the control device. The adverse conditions may negatively affect the performance of the electro-pneumatic controller and/or the position sensor coupled to the control device. The adverse environmental conditions may include relatively extreme temperatures, vibration, humidity, radiation, and/or a combination of those conditions.

As a result of the adverse conditions, the electro-pneumatic controller may be located in a relatively benign and/or controlled environment. Despite not being directly coupled to the control device, the electro-pneumatic controller may be communicatively and/or pneumatically coupled to the control device. Furthermore, the position sensor coupled to the control device may be replaced with a position transmitter capable of providing a position feedback signal despite adverse environmental conditions surrounding the control device.

The apparatus and methods disclosed herein provide a manner in which a position transmitter (i.e., a current output device) may be communicatively coupled to an electro-pneumatic controller without reconfiguring control circuitry and/or processes within the electro-pneumatic controller. The coupling of the electro-pneumatic controller to the position transmitter enables the electro-pneumatic controller to receive a position feedback signal from the position transmitter instead of a position sensor providing, for example, a resistive output. The example methods and apparatus described here provide flexibility to replace, for example, a resistive position sensor with a current output device such as a position transmitter and/or flexibility to locate the electro-pneumatic controller in a different operating environment than the control device.

Furthermore, the example methods and apparatus described herein avoid the creation of ground loops between the electro-pneumatic controller and the position transmitter by isolating respective power supplies to electro-pneumatic controller and the position transmitter. By minimizing and/or eliminating ground loops, the example methods and apparatus reduce the possibility of direct current (DC) offset shifts within the position feedback signal and/or within the electrical circuitry included within the position transmitter and/or the electro-pneumatic controller.

The example methods and apparatus described herein include a configuration in which electrical power is conveyed to the position transmitter via an electrical isolator that receives an alternating current (AC) from a power supply. Additionally, in this configuration, the electro-pneumatic controller determines the position of the actuator and/or the control device based on a voltage drop produced by the feedback current across a resistor within the electrical isolator. In another example configuration, the position transmitter receives power from a DC power supply. Additionally, in this other example, the electro-pneumatic controller determines the position of the actuator and/or the control device based on a voltage drop of the feedback current across a resistor located between a connector of the electro-pneumatic controller receiving the feedback current and a connector of the electro-pneumatic controller coupled to a ground potential.

The disclosed methods and apparatus generally relate to coupling an electro-pneumatic controller to a position transmitter in a process control system. While the disclosed methods and apparatus are described in conjunction with examples involving a pneumatically actuated valve, the disclosed methods and apparatus may be implemented with valves actuated in other manners and/or with process control devices other than valves.

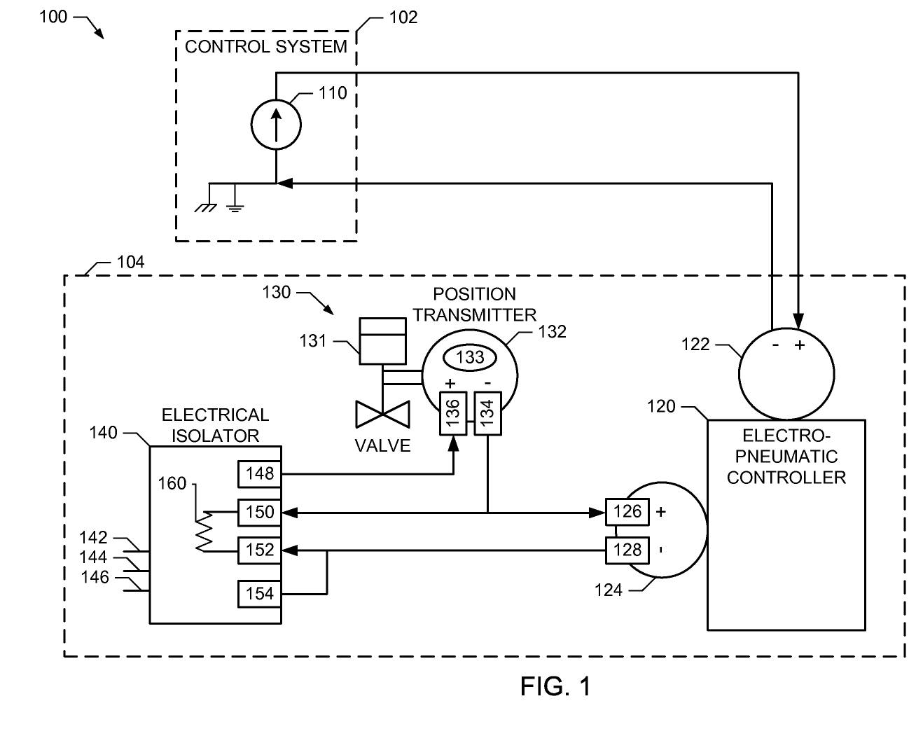

FIG. 1 is a diagram of a process control system 100 including a control system 102 and a process control area 104. The example control system 102 includes a current source 110 that provides power to an electro-pneumatic controller 120 within the process control area 104. The control system 102 may also include workstations, controllers, marshalling cabinets, input/output cards, and/or any other type of process control system management components (not shown).

The example electro-pneumatic controller 120 includes a first terminal box 122 to couple the electro-pneumatic controller 120 to wires carrying supply current from the current source 110. The first terminal box 122 and a second terminal box 124 may include screw connectors and/or any other component to terminate and/or couple a transmission medium (e.g., a wire) to the electro-pneumatic controller 120. In other examples, the power provided to the electro-pneumatic controller 120 may be provided from an external voltage source, a control system, solar power, battery power, etc.

Wires and/or other electrical transmission media carrying the supply current from the current source 110 may also carry control signals from the control system 102. The control signals (e.g., input signals) may include, for example, a 4-20 mA signal, a 0-10 VDC signal, and/or digital commands, etc. The control signals specify or correspond to a valve state for a valve 130. For example, the control signals may cause a pneumatic actuator 131 coupled to the valve 130 to be open, closed, or at some intermediate position.

The power and/or the control signals may share a single wire from the control system 102 or, alternatively, the power and/or the control signals may be received at the first terminal box 122 via multiple wires. For example, in a case where the control signal is a 4-20 mA signal, a digital data communication protocol such as, for example, the well-known Highway Addressable Remote Transducer (HART) protocol may be used to communicate with the electro-pneumatic controller 120. Such digital communications may be used by the control system 102 to retrieve identification information, operation status information and diagnostic information from the electro-pneumatic controller 120. For example, using the HART communications protocol and a two-wire configuration, the control signal in the form of digital data is combined with the power from the current source 110 for the electro-pneumatic controller 120 on a single twisted pair of wires. Furthermore, one of the wires may be coupled to a ground potential. In other examples, the control signal may be a 0-10 VDC signal. Additionally, the wires from the control system 102 to the first terminal box 122 may include separate power wires or lines (e.g., 24 VDC or 24 volts alternating current (VAC)) to power the electro-pneumatic controller 120.

Furthermore, the first terminal box 122 may be replaced or supplemented with one or more wireless communication links. For example, the electro-pneumatic controller 120 may include one or more wireless transceiver units to enable the electro-pneumatic controller 120 to exchange control information (set-point(s), operational status information, etc.) with the control system 102. In the case where one or more wireless transceivers are used by the electro-pneumatic controller 120, the power may be supplied to the electro-pneumatic controller 120 via, for example, wires to a local or remote power supply (e.g., the current source 110).

The example electro-pneumatic controller 120 of FIG. 1 controls the position of the actuator 131 and, thus, the position of the valve 130. The electro-pneumatic controller 120 may include, although not shown, a control unit, a current-to-pneumatic (I/P) converter, and a pneumatic relay. In other examples, the electro-pneumatic controller 120 may include any other components for controlling and/or providing pressure to the valve actuator 131. Additionally, the electro-pneumatic controller 120 may include other signal processing components such as, for example, analog-to-digital converters, filters (e.g., low-pass filters, high-pass filters, and digital filters), amplifiers, etc. For example, the control signal received from the control system 102 may be filtered (e.g., using a low/high pass filter) prior to being processed by a control unit within the electro-pneumatic controller 120.

More specifically, the electro-pneumatic controller 120 controls the position of the actuator 131 by comparing a feedback signal generated by a position transmitter 132 to the control signal originating from the control system 102. The feedback signal is received by the electro-pneumatic controller 120 via the second terminal box 124 that includes connections 126 and 128. The electro-pneumatic controller 120 determines the feedback signal based on the voltage differential produced and/or generated by the feedback current between the first connection 126 and the second connection 128.

The control signal provided by the control system 102 may be used by the electro-pneumatic controller 120 as a set-point or reference signal corresponding to a desired operation (e.g., a desired position corresponding to a percentage of a control valve 130 operating span) of the valve 130. The control unit within the electro-pneumatic controller 120 compares the feedback signal to the control signal by using the control signal and the feedback signal as values in a position control algorithm or process to determine a drive value. The position control process performed by the control unit determines (e.g., calculates) the drive value based on the difference between the feedback signal and the control signal. This calculated difference corresponds to an amount the electro-pneumatic controller 120 is to change the position of the actuator 131 coupled to the valve 130. The calculated drive value also corresponds to a current generated by the control unit to cause an I/P converter within the electro-pneumatic controller 120 to generate a pneumatic pressure.

The I/P converter within the electro-pneumatic controller 120 may be a current-to-pressure type transducer that generates a magnetic field based on the current applied through the solenoid. The solenoid magnetically controls a flapper that operates relative to a nozzle to vary a flow restriction through the nozzle/flapper to provide a pneumatic pressure that varies based on the average current through the solenoid. This pneumatic pressure is amplified by the pneumatic relay and applied to the actuator 131 coupled to the valve 130. The pneumatic relay within the electro-pneumatic controller 120 may be pneumatically coupled to the actuator 131 to provide the actuator 131 with a pneumatic pressure (not shown).

For example, drive values that increase the current generated by the control unit within the electro-pneumatic controller 120 may cause the pneumatic relay to increase a pneumatic pressure applied to the pneumatic actuator 131 to cause the actuator 131 to position the valve 130 towards a closed position. Similarly, drive values that decrease the current generated by the control unit may cause the pneumatic relay to decrease the pneumatic pressure applied to the pneumatic actuator 131 to cause the actuator 131 to position the valve 130 towards an open position.

In other examples the electro-pneumatic controller 120 may include a voltage-to-pressure type of transducer, in which case the drive signal is a voltage that varies to provide a varying pressure output to control the valve 130. Additionally, other examples may implement other types of pressurized fluid including pressurized air, hydraulic fluid, etc.

The example valve 130 of FIG. 1 includes a valve seat defining an orifice that provides a fluid flow passageway between an inlet and an outlet. The valve 130 may be, for example, a rotary valve, a quarter-turn valve, a motor-operated valve, a damper, or any other control device or apparatus. The pneumatic actuator 131 coupled to the valve 130 is operatively coupled to a flow control member via a valve stem, which moves the flow control member in a first direction (e.g., away from the valve seat) to allow fluid flow between the inlet and the outlet and in a second direction (e.g., toward the valve seat) to restrict or prevent fluid flow between the inlet and the outlet.

The actuator 131 coupled to the example valve 130 may include a double-acting piston actuator, a single-acting spring return diaphragm or piston actuator, or any other suitable actuator or process control device. To control the flow rate through the valve 130, the valve is coupled to the position transmitter 132. In other examples, the valve 130 may be coupled to a position sensor and/or a pressure sensor that may include, for example, a potentiometer and/or a magnetic sensor. The position transmitter 132 may be coupled to the valve 130 in cases where the operating environment of the valve 130 is too adverse for other types of position sensors and/or pressure sensors such as devices that only provide a resistive output.

The position transmitter 132 detects the position of the actuator 131 and, thus, the position of the flow control member relative to the valve seat (e.g., an open position, a closed position, an intermediate position, etc.). The position transmitter 132 is configured to provide or generate a feedback signal such as, for example, a mechanical signal, an electrical signal, etc. to the electro-pneumatic controller 120. The feedback signal may represent a position of the actuator 131 coupled to the valve 130 and, thus, a position of the valve 130.

The example methods and apparatus described herein enable the electro-pneumatic controller 120 to receive a feedback signal from any type of example position transmitter 132 of FIG. 1 that can be coupled to the valve 130. The position transmitter 132 includes a position sensor 133 to sense the position of the actuator 131 coupled to the valve 130. The position sensor 133 may include a potentiometer, a magnetic sensor, a piezo-electric transducer, a hall effect sensor, a string potentiometer, etc. The position sensor 133 within the position transmitter 132 operates as a transducer to convert a linear motion of the actuator 131 corresponding to a position of the actuator 131 into a feedback current signal.

The position transmitter 132 includes a position sensor (e.g., the position sensor 133) that is not substantially affected by adverse environmental conditions. The position transmitter 132 may also include electro-magnetic suppression circuitry, noise filtering circuitry, vibration immunity components, and/or radiation shielding components to further isolate or protect the position sensor 133 from adverse environmental conditions. The position transmitter 132 is coupled to the electro-pneumatic controller 120 via a first connection 134 that is coupled to the first connection 126 of the electro-pneumatic controller 120. Additionally, the position transmitter 132 includes a second connection 136 that receives power from a power source.

The example process control area 104 includes an electrical isolator 140 to convey electrically isolated power to the position transmitter 132. In other words, the power conveyed to the position transmitter 132 via the electrical isolator 140 is electrically isolated from the power provided to the electro-pneumatic controller 120 via the current source 110. This electrical isolation minimizes ground loops through the process control system 100. By minimizing ground loops, DC offset shifts are minimized within the feedback signal generated by the position transmitter 132 and/or any voltage electrical signals within the position transmitter 132 and/or the electro-pneumatic controller 120.

In the example of FIG. 1, the electrical isolator 140 receives AC power from a power supply via power supply connections 142-146. To receive the AC power from the power supply, the first power supply connection 142 is coupled to a line input of the power supply, the second power supply connection 144 is coupled to a ground potential of the power supply, and the third power supply connection 146 is coupled to a neutral reference of the power supply. The electrical isolator 140 is configured to use the AC power to provide a power source for the position transmitter 132. For example, the electrical isolator 140 may be configured to output a 20 milliamp (mA) current if the position transmitter 132 is configured to generate a 4-20 mA feedback signal for the electro-pneumatic controller 120. The electrical isolator 140 provides the power to the position transmitter 132 via a third connection 148 of the electrical isolator 140 to the second connection 136 of the position transmitter 132.

Furthermore, the example electrical isolator 140 of FIG. 1 includes connections 150-154 to enable the electro-pneumatic controller 120 to sense a voltage differential produced by the feedback current across a resistor 160. The first connection 150 of the electrical isolator 140 is coupled to the first connection 134 of the position transmitter 132 and the first connection 126 of the electro-pneumatic controller 120. Additionally, the second connection 152 of the electrical isolator 140 is coupled to the second connection 128 of the electro-pneumatic controller 120. The resistor 160 is coupled between the first and second connections 150 and 152 within the electrical isolator 140. The value of the resistor 160 may be selected based on a resolution of the electro-pneumatic controller 120 to accurately determine the voltage differential across the resistor 160 and/or may be selected based on load characteristics of the position transmitter 132. For example, if the resistor is 20 ohms, the voltage differential across the resistor 160 for a 4-20 mA feedback signal will correspond to a voltage differential of 0.08-0.40 volts respectively to the feedback signal.

A current feedback signal is transmitted by the position transmitter 132 via the first connection 134. The electro-pneumatic controller 120 senses the voltage differential of the current feedback signal through the first and the second connections 126 and 128 that are coupled to the respective first and second connections 150 and 152 of the electrical isolator 140. Additionally, the electrical isolator 140 includes a fourth connection 154 at a ground potential that is coupled to the second connection 152.

While the electro-pneumatic controller 120, the position transmitter 132, and the electrical isolator 140 are shown within the process control area 104, each of the electro-pneumatic controller 120, the position transmitter 132, and/or the electrical isolator 140 may be located in a different operating environment and communicatively coupled together via the connections 126, 128, 134, 136, and 148-154. For example, the position transmitter 132 and the electrical isolator 140 may be located within a relatively high temperature and high humidity environment (e.g., 90% humidity and 180 degrees Fahrenheit (° F.)) while the electro-pneumatic controller 120 is located in a controlled environment set to 10% humidity and 72° F.

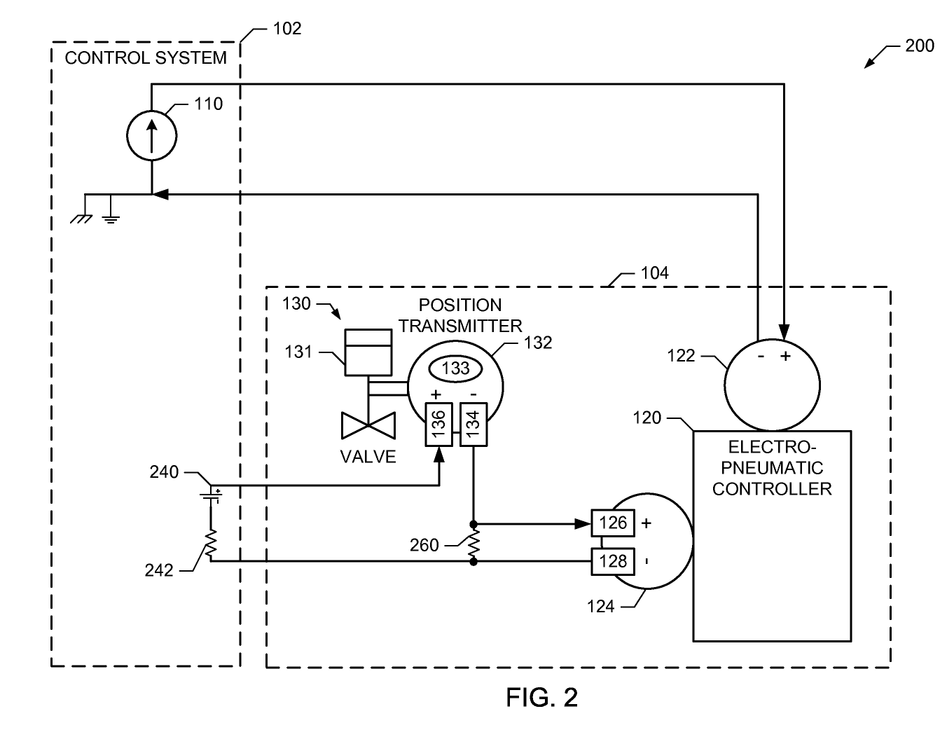

FIG. 2 is a diagram of an example process control system 200 including the example electro-pneumatic controller 120 and the example position transmitter 132 of FIG. 1. that is coupled to a DC power supply 240. Additionally, the process control system 200 of FIG. 2 includes the current source 110, the terminal boxes 122 and 124, the first and second connections 126 and 128 of the electro-pneumatic controller 120, the valve 130, the valve actuator 131, the position sensor 133, and the first and second connections 134 and 136 of the position transmitter 132 of FIG. 1. The current source 110 is coupled to the electro-pneumatic controller 120 in the same manner as in FIG. 1. Furthermore, the actuator 131 is coupled to the valve 130 and the position transmitter 132 in the same manner as in FIG. 1.

In the example process control system 200 of FIG. 2, the control system 102 includes the DC power supply 240. Instead of using the electrical isolator 140 of FIG. 1 to provide power to the position transmitter 132, in the example process control system 200 of FIG. 2 the position transmitter 132 is coupled directly to a power source (e.g., the DC power supply 240). The example DC power supply 240 is shown in series with a resistor 242 to effectively provide a current source to power the position transmitter 132. The DC power supply 240 may include a battery, a voltage generator, a power supply, and/or any other power source and/or circuitry that may generate a DC voltage. For example, if the position transmitter 132 outputs a 4-20 mA feedback current signal, the DC power supply 240 may be 24 volts and the resistor 242 may be 20 ohms to provide sufficient power for the position transmitter 132.

The example position transmitter 132 receives power from the DC power supply 240 via the second connection 136. Additionally, the control system 102 shows the current source 110 and the DC power supply 240 as electrically isolated. To avoid ground loops only the current source 110 is coupled to a ground potential. In other examples, only the DC power supply 240 may be coupled to a ground potential or the second connection 128 of the electro-pneumatic controller 120 may be coupled to a ground potential. In yet other examples, the DC power supply 240, the current source 110 and the second connection 128 of the electro-pneumatic controller 120 may not be coupled to a ground potential.

The example process control area 104 of FIG. 2 includes the electro-pneumatic controller 120, the valve 130 and the position transmitter 132. Because the process control system 200 does not include the electrical isolator 140 with the internal resistor 160 as in the example of FIG. 1, the process control area 104 includes a resistor 260 coupled between the first and the second connections 126 and 128 of the electro-pneumatic controller 120. Additionally, the resistor 260 is coupled to the first connection 134 of the position transmitter 132. The electro-pneumatic controller 120 determines or detects a voltage differential across the resistor 260 produced by the feedback current signal from the position transmitter 132 to calculate a position of the actuator 131 coupled to the valve 130.

The resistor 260 may be coupled between the first and the second connections 126 and 128 within the second terminal box 124 of the electro-pneumatic controller 120. Alternatively, the resistor 260 may be included within the electro-pneumatic controller 120 between circuitry corresponding to the first and the second connections 126 and 128. Furthermore, the example resistor 260 may alternatively be coupled between wires coupled to the first and the second connections 126 and 128 of the electro-pneumatic controller 120.

While the electro-pneumatic controller 120 and the position transmitter 132 are shown within the process control area 104 of FIG. 2, the electro-pneumatic controller 120 and the position transmitter 132 may be located in different operating environments and communicatively coupled together via the connections 126, 128, and 134. For example, the position transmitter 132 may be located within a relatively high temperature and high humidity environment (e.g., 90% humidity and 180 degrees Fahrenheit (° F.)) while the electro-pneumatic controller 120 is located in a controlled environment set to 10% humidity and 72° F.

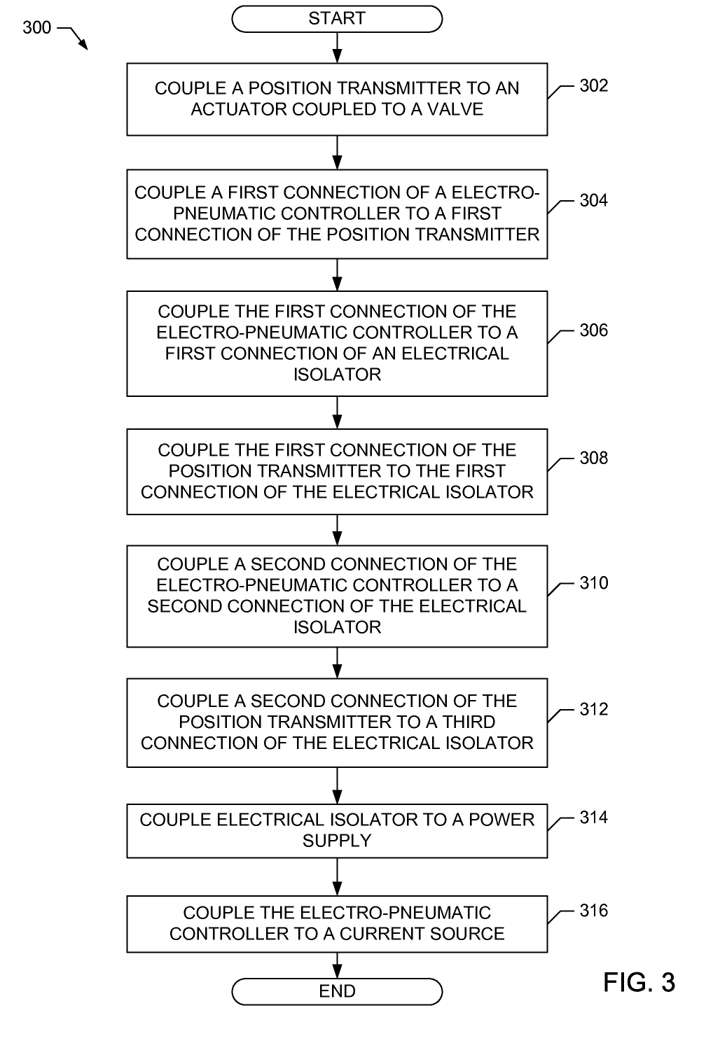

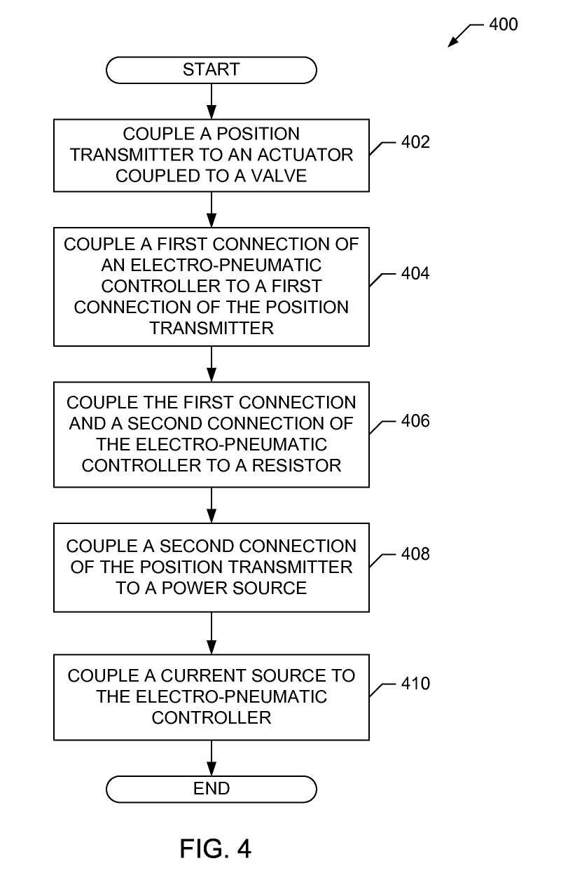

FIGS. 3 and 4 are flowcharts of example methods that may be carried out to couple the example electro-pneumatic controller 120, the example position transmitter 132, the example current source 110, the example power supply 240, and/or the example electrical isolator 140 in the example configurations shown in FIGS. 1 and/or 2. One or more of the example operations of FIGS. 3 and 4 may be implemented using manual operations or as any combination of any of the foregoing techniques such as, for example, any combination of firmware, software, discrete logic and/or hardware. Further, many other methods of implementing the example operations of FIGS. 3 and 4 may be employed. For example, the order of execution of the blocks may be changed, and/or one or more of the blocks described may be changed, eliminated, sub-divided, or combined. Additionally, any or all of the example operations of FIGS. 3 and 4 may be carried out sequentially and/or carried out in parallel by, for example, separate processing threads, processors, devices, discrete logic, circuits, etc.

The example method 300 of FIG. 3 couples the electro-pneumatic controller 120 to the position transmitter 132 using the electrical isolator 140 of FIG. 1. An operator and/or an electrician associated with the process control system 100 may couple the process control devices 120, 132 and 140. However, the example method 300 may be performed in any mechanical and/or electrical manner that results in the process control components 120, 132, and/or 140 being coupled together. The example method 300 of FIG. 3 begins when the position transmitter 132 is coupled to the actuator 131 of FIG. 1 (block 302). The position transmitter 132 may, for example, be coupled to the actuator 131 to replace a position and/or a pressure sensor that does not provide suitable performance in the adverse environmental conditions surrounding the valve 130.

The example method 300 of FIG. 3 continues when the first connection 134 of the position transmitter 132 is coupled to the first connection 126 of the electro-pneumatic controller 120 (block 304). The first connection 126 of the electro-pneumatic controller 120 and the first connection 134 of the position transmitter 132 are then coupled to the first connection 150 of the electrical isolator 140 (blocks 306 and 308). The first connections 126, 134, and 150 may be coupled together via wires, cabling, fiber optics, wireless signals, and/or any other medium than can carry a feedback signal.

Next, the second connection 128 of the electro-pneumatic controller 120 is coupled to the second connection 152 of the electrical isolator 140 (block 310). Additionally, the second connection 136 of the position transmitter 132 is coupled to the third connection 148 of the electrical isolator (block 312). The electrical isolator 140 is then coupled to a power supply (block 314). The power supply may include an AC power supply or, alternatively, a DC power supply. The example method 300 ends when the electro-pneumatic controller 120 is coupled to the current source 110 (block 316).

The example method 400 of FIG. 4 couples the electro-pneumatic controller 120 to the position transmitter 132 that receives power from the power source 240 of FIG. 2. An operator and/or an electrician associated with the process control system 200 may couple the process control devices 120 and 132. However, the example method 400 may be performed in any mechanical and/or electrical manner that results in the process control components 120 and 132 being coupled together. The example method 400 begins when the position transmitter 132 is coupled to the actuator 131 of FIG. 1 (block 402).

The example method 400 of FIG. 4 continues when the first connection 134 of the position transmitter 132 is coupled to the first connection 126 of the electro-pneumatic controller 120 (block 404). The first and the second connections 126-128 of the electro-pneumatic controller 120 are then coupled to the resistor 260 (block 406). Additionally, the first connection 134 of the position transmitter 132 may be coupled to the resistor 260 at the same point as the first connection 126 of the electro-pneumatic controller 120. Furthermore, in some examples, the second connection 128 of the electro-pneumatic controller 120, the current source 110 or the DC power supply 240 may be coupled to a ground potential. Next, the second connection 136 of the position transmitter 132 is coupled to the power source 240 (block 408). The example method 400 ends when the electro-pneumatic controller 120 is coupled to the current source 110 (block 410).

What is claimed is:

1. A process control apparatus comprising:
a position transmitter having a first connection and having a second connection coupled to a power source;
an electro-pneumatic controller including at least a first connection coupled to the first connection of the position transmitter; and
a resistor coupled between the first connection and a second connection of the electro-pneumatic controller.

2. An apparatus as defined in claim 1, wherein the position transmitter includes a position sensor that changes a current signal based on a position of an actuator coupled to a control device.

3. An apparatus as defined in claim 2, wherein the position transmitter transmits the current signal from the first connection of the position transmitter to the first connection of the electro-pneumatic controller.

4. An apparatus as defined in claim 2, wherein the electro-pneumatic controller determines the position of the actuator based on a voltage differential of the current signal across the resistor.

5. An apparatus as defined in claim 2, wherein the position sensor includes at least one of a potentiometer, a magnetic sensor, a piezo-electric transducer, a hall effect sensor, or a string potentiometer.

6. An apparatus as defined in claim 1, wherein the position transmitter includes a pressure sensor that changes a current signal based on a pressure.

7. An apparatus as defined in claim 1, wherein the position transmitter is located in a different process control environment than the electro-pneumatic controller.

8. An apparatus as defined in claim 1, wherein the electro-pneumatic controller receives power from a current source that is electrically isolated from the power source.

9. A process control apparatus:
a position transmitter having first and second connections;
an electrical isolator having first, second, and third connections, wherein the third connection of the electrical isolator is coupled to the second connection of the position transmitter; and
an electro-pneumatic controller including at least a first connection coupled to the first connection of the position transmitter and the first connection of the electrical isolator, wherein the electro-pneumatic controller includes a second connection coupled to the second connection of the electrical isolator.

10. An apparatus as defined in claim 9, wherein the electrical isolator includes a resistor coupled between the first and the second connections of the electrical isolator.

11. An apparatus as defined in claim 10, wherein the position transmitter includes a position sensor that changes a current signal based on a position of an actuator coupled to the valve.

12. An apparatus as defined in claim 11, wherein the electro-pneumatic controller determines the position of the actuator based on a voltage differential of the current signal across the resistor.

13. An apparatus as defined in claim 11, wherein the position transmitter transmits the current signal from the first connection of the position transmitter to the first connection of the electro-pneumatic controller.

14. An apparatus as defined in claim 11, wherein the position sensor includes at least one of a potentiometer, a magnetic sensor, a piezo-electric transducer, a hall effect sensor, or a string potentiometer.

15. An apparatus as defined in claim 9, wherein the position transmitter includes a pressure sensor that is to change a current signal based on a pressure.

16. An apparatus as defined in claim 9, wherein the position transmitter is located in a different process control environment than the electro-pneumatic controller.

17. An apparatus as defined in claim 9, wherein the electrical isolator is to convey power to the position transmitter from the third connection of the electrical isolator to the second connection of the position transmitter.

18. An apparatus as defined in claim 17, wherein the electrical isolator receives power from a power supply.

19. An apparatus as defined in claim 9, wherein the electro-pneumatic controller receives power from a current source that is electrically isolated from the electrical isolator.

20. A method to couple an electro-pneumatic controller to a position transmitter in a process control system, the method comprising:
coupling a first connection of an electro-pneumatic controller to a first connection of a position transmitter;
coupling the electro-pneumatic controller to a resistor by coupling the resistor between the first connection and a second connection of the electro-pneumatic controller; and
coupling a second connection of the position transmitter to a power source.

21. A method as defined in claim 20, wherein the resistor and a ground potential are within an electrical isolator, wherein the resistor is coupled between a first connection and a second connection of the electrical isolator.

22. A method as defined in claim 21, wherein first connection of the electro-pneumatic controller is coupled to the first connection of the electrical isolator and the second connection of the electro-pneumatic controller is coupled to the second connection of the electrical isolator.

23. A method as defined in claim 21, wherein the electrical isolator provides a power source to the position controller from a third connection of the electrical isolator coupled to the second connection of the position transmitter.

24. A method as defined in claim 20, further comprising coupling a current source to the electro-pneumatic controller.

25. A method as defined in claim 24, wherein the current source and power source are electrically isolated.
